(19) United States
(12) Patent Application Publication
(10) Pub. No.: US 2005/0118497 A1
(43) Pub. Date: Jun. 2, 2005

(54) Method and assembly for evaluating the state of charge of batteries

(76) Inventor: Thomas B. Breen, Broomall, PA (US)

Correspondence Address: BUCHANAN INGERSOLL PC, 1835 MARKET STREET, 14TH FLOOR, PHILADELPHIA, PA, 19103-2985, US

(21) Appl. No.: 10/725,069

(22) Filed: Dec. 1, 2003

(51) Int. Cl. H01M 10/48; G01N 27/416

(52) U.S. Cl. 429/93; 324/426

(57) ABSTRACT

The invention comprises a method and assembly for determining the state of charge of a battery or batteries without disturbing them or removing them from their packaging, or from a device in which they are installed, or from an enclosure preventing direct physical contact with the battery terminals. The battery terminals are electrically insulated from all connections except connections to conductors extending away from the terminals. The state of charge can be determined by attaching a measuring device to the conductors. The conductors and insulators are easily removed, allowing the terminals to come into contact with a battery-powered device.

### FIELD OF THE INVENTION

The invention relates to the field of battery evaluation. More specifically, it relates to methods and assemblies for determining the state of charge of one or more batteries without disturbing the surrounding environment of the batteries.

### BACKGROUND OF THE INVENTION

Battery-operated electrical devices are very common, and in many situations it is desirable to determine the state of charge of the batteries before they are used to provide power to a device. It is also desirable that this determination be made as quickly and easily as possible. The need to assess the state of charge can be especially crucial in situations where a battery has been idle for an extended time period but must then reliably supply power at any given moment. In such situations recharging or replacing defective batteries alone may be too time consuming or even impossible, and replacing an entire electronic or electrical assembly is the only feasible remedy, once the battery state of charge is quickly determined. A quick and easy method of battery testing would be beneficial in such areas as emergency equipment, military equipment, and avionics.

As one example, flashlights and batteries to power them are often kept in storage for use during a power outage or other emergency. A supply of charged batteries must be immediately available at all times. An easy way to monitor the state of charge of such stored batteries is clearly essential.

Another example is an alarm system that must be put into service immediately upon installation. It would be highly desirable for full battery capacity to be available to provide full functionality of the alarm system without waiting for the batteries to become charged.

As another example, quality control of battery-operated devices would be facilitated by a convenient battery evaluation. A charged battery may gradually become discharged while on an assembly line, after sitting for a long time in a warehouse, or after being delivered to a customer. A simple way to check the state of charge of the battery would benefit the manufacturer and purchaser alike.

U.S. Pat. No. 3,454,873, granted to Abrahams discloses a very simple battery test device using a small light bulb as indicator. Although simple and convenient, this device provides only a crude, qualitative indication of the state of charge, not sufficient for the applications described above.

A battery tester is often included in the packaging of AA or 9-volt batteries. One attaches the positive and negative battery terminals to the tester and a colored display indicates whether the battery is fully charged, partially charged, or only minimally charged. These battery testers are typically rather complex multilayer flat structures incorporating a thermochromic or electrochromic material, one which changes color in response to heat or electric fields, respectively. Such testers are disclosed in U.S. Pat. Nos. 5,223,003; 5,389,458; and 5,418,085; U.S. Patent Application Publication US/0049522; and EP Application Publication 0 495 636 A2.

Another class of battery testers makes use of a separate electrochemical or electrolytic cell, as disclosed in U.S. Pat. Nos. 5,627,472 and 5,596,278. However, the need for an extra cell makes such testers relatively complex and costly.

U.S. Pat. No. 6,291,096 B1 discloses a relatively simple tester that continuously displays the state of charge of a battery, with no action required by the user. While offering convenience, this device must continuously draw a small current from the battery, which could discharge the battery over a prolonged idle period.

There is thus a need for a simple, quick, and inexpensive method and apparatus for assessing the state of charge of batteries prior to use. For greatest convenience, one should be able to assess the batteries without disturbing them or removing them from their packaging or from a device in which they are installed.

### BRIEF DESCRIPTION OF THE INVENTION

The invention comprises a method and assembly for quickly and easily evaluating the state of charge of at least one battery without disturbing the batteries. In one embodiment, the batteries are physically installed in a battery-operated device, but the battery terminals are electrically insulated from contact areas of the device by insulating material between the terminals and the contact areas. The purpose of this insulating is to minimize loss of battery charge before the device is put into operation. At the same time, positive and negative battery terminals are each in electrical contact with an electrical conductor, and these conductors extend outward from the battery-operated device. This enables a user to bring the battery terminals into electrical contact with a measuring device, such as a voltmeter, and thereby determine the state of charge of the battery or batteries. If the state of charge is determined to be acceptable, the insulating material may then be removed, bringing the battery terminals into electrical contact with the contact areas of the battery-powered device, thereby activating the device. If the state of charge is found to be unacceptable, the battery may be recharged or replaced or the entire assembly of battery and battery-operated device may be replaced and the state of charge measured again.

In another embodiment, the batteries, with or without a battery-operated device, are either partially or fully enclosed in such a way that direct physical contact with the actual terminals of the batteries is not possible. Conductors, connected to battery terminals at one end, extend to the outside of the enclosure, thereby allowing one to determine the state of charge of the batteries by attaching a measuring device to the conductors outside the enclosure. An example of this embodiment is batteries enclosed in a package, with the conductors extending to the outside of the package.

### BRIEF DESCRIPTION OF THE FIGURES

FIG. 1 is an exploded view showing a battery, conductors, device contact areas, and a measuring device displaying the state of charge of the battery.

FIG. 2 is an overall view of one embodiment of the invention, showing a battery with attached conductors and a battery-powered device.

FIG. 3 shows another embodiment of the invention, a package enclosing a battery with the conductors and test points on the outside of the package.

### DETAILED DESCRIPTION OF THE INVENTION

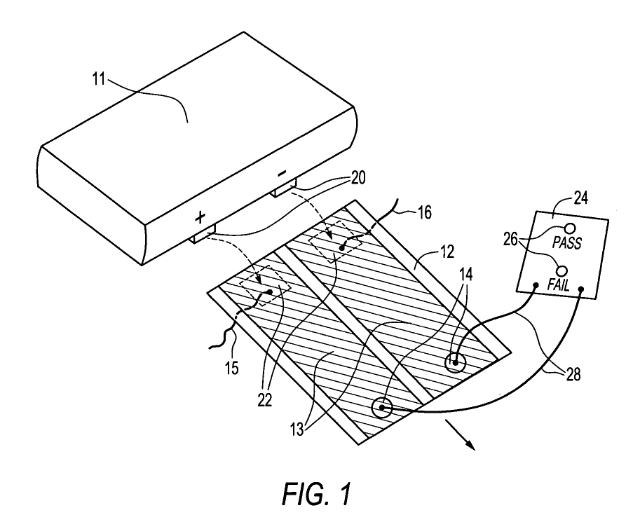

FIG. 1 is an exploded view illustrating an assembly as an embodiment of the invention. A battery 11 has two terminals 20, one positive and one negative. The terminals make electrical contact with two conductors 13 as indicated by the dashed arrows. The battery terminals 20 are electrically insulated from device contact areas 22 which are connected by wires 15 and 16 to a battery-operated device (not shown). This insulation is achieved by electrically insulating material 12 situated underneath the conductors 13. The state of charge of the battery is determined by bringing the probes 28 of a measuring device 24 into electrical contact with the conductors 13 at the test points indicated by the targets 14. The battery state of charge is displayed by lights 26 on the face of the measuring device 24.

Once the state of charge is determined, the battery-operated device may be activated by removing the conductors 13 and insulator 12 by pulling in the direction of the solid arrow. Once this is done the battery terminals 20 will be in electrical contact with the device contact areas 22 and power from the battery will be conveyed to the battery-powered device through the wires 15 and 16 connected to the device contact areas 22.

Alternatively, the conductors 13 could be sandwiched between two layers of insulting material. In this case the layer indicated by 12 in FIG. 1 becomes a bottom insulating layer, and an additional top insulating layer is placed over the conducting stripes 13 to provide additional protection against accidentally short-circuiting the battery. A portion of this top layer may be removed at the end nearest the battery terminals 20 to allow the terminals 20 to come into electrical contact with the conductors 13.

In one embodiment the insulating material 12 and the conductors 13 are integrated into a single unit in the form of a flat flexible ribbon. The insulating material 12 must withstand the voltage of the battery 11 without breakdown and without allowing leakage currents to flow. It should also have a slippery quality, allowing it to be easily removed by sliding. It must also have sufficient mechanical integrity so as not to be punctured, tom, or otherwise penetrated by the battery terminals 20 or device contact areas 22. Suitable materials for the insulator 12 include, but are not limited to, bonded spun polymeric material such as those known by the trademark TYVEK®; polymeric paper, pressboard, nonwoven materials, and film materials, such as those known by the trademarks TEFLON®, KAPTON®, MYLAR®, KYNAR®, and NOMEX®; or paper coated with a wax or a resin.

Also in this embodiment, the conductors 13 are in the form of thin film-like stripes of conducting material, providing connections between the battery terminals and the measuring device. Preferably, these stripes may be fabricated on the insulating material by a process such as, but not limited to, painting, spraying, printing, or silk-screen printing. Suitable materials for the conducting stripes include, but are not limited to, carbon ink, thin carbon films, and conductive epoxies.

In another embodiment the resistance of the stripes 13 is relatively high and the measuring device 24 is a high-impedance voltmeter which measures the open-circuit voltage of the battery 11. An advantage of using such high-impedance conductors is that very little current is drawn from the battery during the test. A further advantage is that the high resistance of the stripes 13 will limit the current drawn from the battery 11, thereby preventing damage to the battery in the event that the conductors 13 are bridged or “shorted” by highly conducting material. Alternatively, at least one of the conductors 13 could be in series with a resistance high enough to prevent damage to the battery by limiting the current in the event the conductors are bridged. Alternatively, at least one of the conductors 13 could be in series with a fuse, which is designed to open in the event the conductors are bridged, thereby protecting the battery.

In other embodiments, the measuring device 24 could be an ammeter for measuring current, a thermochromic, electrochromic, or electrophoretic device, or an electrochemical cell or an electrolytic cell.

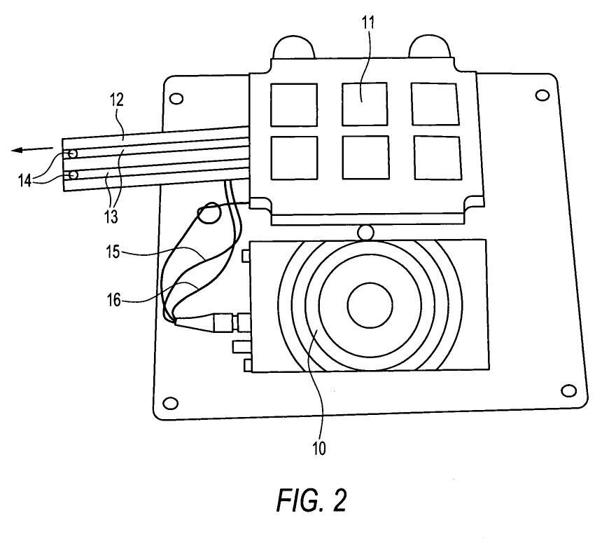

FIG. 2 shows an overall view of an exemplary embodiment of the invention, an example of an asset-tracking device. This embodiment of the invention is incorporated in a unit, which is mounted on a mobile trailer. The unit determines and communicates the location of the mobile trailer by making use of the Global Positioning System (GPS) and low-earth-orbit communication satellites. A battery 11 is mounted next to a battery-operated device 10, in this case an integrated GPS detector and satellite transceiver. Two conducting stripes 13 make contact with the battery terminals (not visible) and extend beyond the edge of the assembly. The conducting stripes are integral with a strip of electrically insulating material 12. At the end of each conductor is a test target 14, indicating where the probes of a measuring device are to be placed in order to determine the state of charge of the battery. If the state of charge is found to be acceptable, the unit is attached to the trailer and the device 10 is activated. Activation is achieved by removing the integrated insulating strip 12 and conductors 13 in the direction of the arrow, thereby allowing electrical contact between the terminals (not shown) of the battery 11 and device contact areas (not shown). The battery 10 then supplies power to the device 10 through wires 15 and 16.

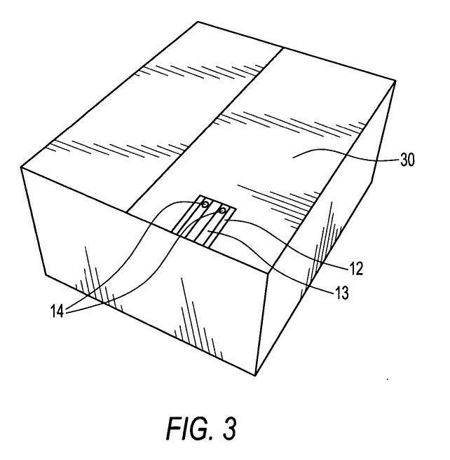

FIG. 3 shows another exemplary embodiment of the invention, a package 30, containing a battery (not shown) either alone or with a battery-operated device. This embodiment enables the state of charge of the battery to be determined without opening the package 30, since the conductors 13 and test points 14 are on the outside of the package 30. This is especially helpful for quality control in manufacturing and shipping. The state of charge of the battery could be checked before packaging, just before shipping (perhaps after sitting for a long time in a warehouse), and upon receipt by the end user. In particular, testing on an assembly line or elsewhere could be automated for batteries packaged according to this embodiment.

In this embodiment, the conducting stripes 13 are connected to the battery terminals at one end (not shown) and the stripes 13 extend to and terminate on the outside of the package 30. The state of charge of the battery may be determined by placing the probes of a measuring device on the two test point targets 14. The battery terminals are electrically isolated from each other and from other conductors by the insulating material 12.

If the state of charge is found unacceptable the package may be returned to the vendor unopened, thereby avoiding time and costs associated with repackaging and with replacing the battery after it is installed.

It is to be understood that the descriptions and embodiments described above are exemplary, and are not to be taken as limiting the scope of the invention. Alternatives, modifications, and variations, which do not depart from the spirit and scope of this invention, will be apparent to those skilled in the art. The scope of this invention is to be defined by the following claims:

1. A method for determining the state of charge of at least one battery installed in a battery-powered device without removing said at least one battery from said device, or otherwise altering the device, the method comprising the steps of:
a. electrically insulating the terminals of said at least one battery from contact areas of the battery-powered device with an electrically insulating material,
b. bringing a positive battery terminal into contact with a first conductor and a negative battery terminal into contact with a second conductor, said first and second conductors extending from said at least one battery,
c. determining the state of charge of said at least one battery by attaching a measuring device to said first and second conductors, and
d. deciding whether the state of charge is acceptable or unacceptable, based on predetermined criteria.

2. The method of Claim I, wherein the device is enclosed by a package and said first and second conductors are extended to the outside of the package, allowing the state of charge of said at least one battery to be determined without opening the package.

3. The method of claim 1, further comprising the steps of:
e. replacing or recharging said at least one battery if the state of charge, as determined by the method of claim 1, is unacceptable, and
f. repeating steps a through d.

4. The method of claim 1, further comprising the step of removing the insulating material if the state of charge is determined to be acceptable, bringing said terminals of said at least one battery into electrical contact with the contact areas of the battery-powered device.

5. The method of claim 4, wherein the insulating material is flexible, and has a slippery quality allowing it to be easily removed from the device and battery by sliding, and has sufficient mechanical integrity so as not to be punctured, tom, or otherwise penetrated by the battery terminals or contact areas.

6. The method of claim 5, wherein the insulating material is bonded spun polymeric material, polymeric paper, pressboard, nonwoven material, film, or paper coated with a wax or a resin.

7. The method of claim 1, wherein the measuring device is a voltmeter or other voltage-measuring device.

8. The method of claim 7, wherein the voltmeter is of sufficiently high impedance to give an accurate reading of the open circuit voltages of said at least one battery.

9. The method of claim 1, wherein the measuring device indicates whether the state of charge is acceptable or unacceptable.

10. The method of claim 1, wherein said first and second conductors and said insulating material form a single, integrated unit.

11. The method of claim 10, wherein the first and second conductors are sandwiched between a top layer and a bottom layer of insulating material and a portion of said top layer near the battery terminals is removed, allowing electrical contact between the conductors and the battery terminals.

12. The method of claim 10, wherein the first and second conductors are applied to the insulating material by painting, spraying, printing, or silk-screen printing.

13. The method of claim 1, wherein said first and second conductors are formed using carbon ink, thin carbon films, or conductive epoxy.

14. The method of claim 1 wherein said first and second conductors are marked to show a user where the contacts of the measuring device should be placed.

15. The method of claim 1, wherein the resistance of said first and second conductors is high enough to prevent damage to said at least one battery by limiting the current in the event that the conductors are bridged.

16. The method of claim 1, wherein at least one of said first and second conductors is in series with a resistance high enough to prevent damage to said at least one battery by limiting the current in the event the conductors are bridged.

17. The method of claim 1, wherein at least one of said first and second conductors is in series with a fuse, said fuse designed to open in the event the conductors are bridged, protecting said at least one battery.

18. The method of claim 1, wherein the measuring device is an ammeter or other current-measuring device.

19. The method of claim 1, wherein the measuring device is a thermochromic, electrochromic, or electrophoretic device; electrochemical cell, or electrolytic cell.

20. The method of claim 1, wherein the battery-operated device is an asset-tracking device comprising a satellite transceiver.

21. The method of claim 1, wherein the battery-operated device is a locating device comprising a satellite transceiver and a Global Positioning System receiver.

22. The method of claim 1, wherein said at least one battery is charged from an external source.

23. An assembly, comprising at least one battery and a battery-powered device, which allows the state of charge of said at least one battery to be determined without removing said at least one battery or otherwise altering the assembly, the assembly further comprising a first electrical conductor in electrical contact with a positive terminal of said at least one battery, and a second electrical conductor in electrical contact with a negative terminal of said at least one battery, said first and second conductors extending from the assembly and allowing a measuring device to be placed in electrical contact with said conductors, the reading of said measuring device determining the state of charge of said at least one battery.

24. The assembly of claim 23, wherein the device is enclosed by a package and said first and second conductors are extended to the outside of the package, allowing the state of charge of said at least one battery to be determined without opening the package.

25. The assembly of claim 23, further comprising insulating material, which electrically isolates the terminals of said at least one battery from the contact areas of the device, said insulating material being removable once the assembly is installed in its place of operation, providing electrical contact between said terminals and the battery-powered device.

26. The assembly of claim 25, wherein the insulating material is flexible, and has a slippery quality allowing it to be easily removed from the device and battery by sliding, and has sufficient mechanical integrity so as not to be punctured, torn, or otherwise penetrated by the battery terminals or contact areas.

27. The assembly of claim 26, wherein the insulating material is bonded spun polymeric material, polymeric paper, pressboard, nonwoven material, film, or paper coated with a wax or a resin.

28. The assembly of claim 25, wherein said first and second conductors are formed using carbon ink, thin carbon films, or conductive epoxy.

29. The assembly of claim 25, wherein said first and second conductors and the insulating material form a single, integrated unit.

30. The assembly of claim 29, wherein the first and second conductors are applied to the insulating material by painting, spraying, printing, or silk-screen printing.

31. The assembly of claim 29, wherein the first and second conductors are sandwiched between a top layer and a bottom layer of insulating material and a portion of said top layer near the battery terminals is removed, allowing electrical contact between the conductors and the battery terminals.

32. The assembly of claim 23, wherein said first and second conductors are marked to show a user where the contacts of the measuring device should be placed.

33. The assembly of claim 23, wherein the resistance of said first and second conductors is high enough to prevent damage to said at least one battery by limiting the current in the event that the conductors are bridged.

34. The assembly of claim 23, wherein at least one of said first and second conductors is in series with a resistance high enough to prevent damage to said at least one battery by limiting the current in the event the conductors are bridged.

35. The assembly of claim 23, wherein at least one of said first and second conductors is in series with a fuse, said fuse designed to open in the event the conductors are bridged, protecting said at least one battery.

36. The assembly of claim 23, wherein the battery-operated device is an asset-tracking device comprising a satellite transceiver.

37. The assembly of claim 23, wherein the battery-operated device is a locating device comprising a satellite transceiver and a Global Positioning System receiver.

38. The assembly of claim 23, wherein said at least one battery is charged from an external source.

39. The assembly of claim 38, wherein said at least one battery is charged from the engine of a motor vehicle, the entire assembly being attached to a trailer which is attachable to and detachable from said motor vehicle.

40. A unit for determining and communicating the location of a mobile trailer, said unit making use of the Global Positioning System (GPS) and designed to be mounted on said trailer, said unit comprising:
a. a GPS receiver,
b. a communications satellite transceiver, and
c. a battery assembly which supplies electrical power to the transceiver,
wherein the state of charge of a battery in the assembly can be determined prior to the activation of the unit without removing said battery or otherwise altering the unit, the battery assembly comprising:
(i) a battery, having a positive battery terminal and a negative battery terminal,
(ii) a first metallic contact area in proximity to the positive battery terminal and a second metallic contact area in proximity to the negative battery terminal,
(iii) a first wire with its proximal end connected to said first metallic contact area and its distal end connected to a first terminal of the transceiver; and a second wire having its proximal end connected to said second metallic contact area and its distal end connected to a second terminal of the transceiver,
(iv) a ribbon, having its proximal end disposed between said metallic contact areas and said battery terminals and extending to a distal end, said ribbon comprising a first stripe and a second stripe, said stripes being parallel to one another and comprised of electrically conducting material, said stripes sandwiched between a top layer and a bottom layer of electrically insulating material, wherein said top layer has been removed over a short distance at said proximal end, exposing said conducting stripes and allowing said positive battery terminal to come into electrical contact with said first conducting stripe at said proximal end, and said negative battery terminal to come into electrical contact with said second conducting stripe at said proximal end, and
(v) a first target situated over said first conducting stripe at said distal end and a second target situated over said second conducting stripe at said distal end, said first and second targets indicating where the probes of a measuring device are to be placed, said measuring device indicating the state of charge of the battery.

41. The unit of claim 40 wherein said top layer has been removed over a short distance at said distal end, exposing said first and second conducting stripes and allowing probes of said measuring device to come into electrical contact with said first and second conducting stripes at said distal end.

42. A battery assembly comprising: a battery, a first electrical conductor in electrical contact with a positive terminal of said battery, and a second electrical conductor in electrical contact with a negative terminal of said battery, said first and second conductors extending away from said battery, such that a measuring device may be placed in electrical contact with said conductors, the reading of said measuring device determining the state of charge of said battery, said first conductor and second conductor being of sufficient length such that when said battery is contained in an enclosure such that direct contact with the terminals of said battery is not possible, said first conductor and second conductor extend to the outside of said enclosure, allowing the state of charge of said battery to be determined.

43. The battery assembly of claim 42, said assembly further comprising electrically insulating material in proximity to the terminals of said battery, said insulating material being removable when said battery is installed in a battery-powered device, providing electrical contact between said terminals and contact areas of said battery-powered device.

44. The battery assembly of claim 43, wherein the insulating material is flexible, and has a slippery quality allowing it to be easily removed from the battery by sliding, and has sufficient mechanical integrity so as not to be punctured, torn, or otherwise penetrated by the battery terminals or contact areas.

45. The battery assembly of claim 44, wherein the insulating material is bonded spun polymeric material, polymeric paper, pressboard, nonwoven material, film, or paper coated with a wax or a resin.

46. The battery assembly of claim 43, wherein said first and second conductors and said insulating material form a single, integrated unit.

47. The battery assembly of claim 46, wherein said first and second conductors are formed using carbon ink, thin carbon films, or conductive epoxy.

48. The battery assembly of claim 46, wherein the first and second conductors are applied to the insulating material by painting, spraying, printing or silk-screen printing.

49. The battery assembly of claim 46, wherein the first and second conductors are sandwiched between a top layer and a bottom layer of insulating material and a portion of said top layer near the battery terminals is removed, allowing electrical contact between the conductors and the battery terminals.

50. The battery assembly of claim 42, wherein said first and second conductors are marked to show a user where the contacts of the measuring device should be placed.

51. The battery assembly of claim 42, wherein the resistance of said first and second conductors is high enough to prevent damage to said battery by limiting the current in the event that the conductors are bridged.

52. The battery assembly of claim 42, wherein at least one of said first and second conductors is in series with a resistance high enough to prevent damage to said battery by limiting the current in the event the conductors are bridged.

53. The battery assembly of claim 42, wherein at least one of said first and second conductors is in series with a fuse, said fuse designed to open in the event the conductors are bridged, protecting said battery.

54. The battery assembly of claim 42, wherein said enclosure is a package, with the conductors extending to the outside of said package.
